(19) United States
(12) Patent Application Publication
(10) Pub. No.: US 2002/0043156 A1
(43) Pub. Date: Apr. 18, 2002

(54) Integrated air filter and hydrocarbon adsorber

(76) Inventor: Michael Richard Shea, Grand Blanc, MI (US)

Correspondence Address: DELPHI TECHNOLOGIES, INC., Legal Staff, Mail Code: 480-414-420, P.O. Box 5052, Troy, MI, 48007-5052, US

(21) Appl. No.: 09/960,860

(22) Filed: Sep. 21, 2001

Related U.S. Application Data
(60) Provisional application No. 60/239,863, filed on Oct. 11, 2000.

(51) Int. Cl. B01D 53/04

(52) U.S. Cl. 96/134; 96/154

(57) ABSTRACT

An integrated air filter and hydrocarbon adsorbing apparatus includes an air filter comprising a filter media disposed on a screen support and an air permeable hydrocarbon adsorbing material disposed between the filter media and the screen support at the air stream outlet end of the apparatus. The hydrocarbon adsorbing material is situated to adsorb hydrocarbon emissions at the clean air side of an air stream flowing through the apparatus. The treated air stream exits through the air stream outlet, typically to an inlet of an engine air induction system. In an alternate embodiment, the integrated air filter and hydrocarbon adsorbing apparatus comprises a hydrocarbon adsorbing coating directly disposed on a portion of the air filter adjacent the air stream outlet.

### CROSS-REFERENCE TO RELATED APPLICATIONS

The present application claims priority to U.S. Provisional Application No. 60/239,863 of Michael Richard Shea, filed Oct. 11, 2000, entitled “Integrated Air Filter and Hydrocarbon Adsorber,” Attorney Docket No. DP-303921.

### TECHNICAL FIELD

The present invention relates to an integrated air filter and hydrocarbon adsorber.

### BACKGROUND OF THE INVENTION

Concern for the environment and ever increasingly strict emissions regulations require automotive manufacturers to reduce greatly or eliminate altogether gasoline emissions from air induction systems when the automobile is shut off These evaporative emissions are created by unburned fuel remaining in the intake manifold once the engine stops. A closed system approach for controlling these emissions comprises blocking off the induction system thereby preventing gasoline vapors from leaking out. An open system approach comprises adsorbing the gasoline with a hydrocarbon (HC) adsorber.

One effort for controlling these evaporative emissions comprises placing an extruded carbon monolith in the ductwork of the air induction system. Problematically, this approach results in an unacceptable amount of air restriction, thus adversely affecting engine horsepower.

Carbon impregnated materials may be used to adsorb hydrocarbon emissions. Typically, carbon powder is mixed with a phenolic resin (or binder) and applied to a base material. In one investigation, a resin impregnated cellulose material was employed in place of the air filter. Unfortunately, the resin used to bind the carbon closed off the pores in the carbon, thus eliminating its ability to adsorb hydrocarbons.

A major challenge for creating a HC adsorber for the air induction system is to minimize the impact of the HC adsorber on the air intake restriction. A further challenge is to create a HC adsorber that adds little cost to the system, keeps restriction low, and provides sufficient hydrocarbon adsorption capacity for the particular application.

### SUMMARY OF THE INVENTION

The present invention relates to an integrated air filter and hydrocarbon adsorbing apparatus comprising a housing securing an air filter having an air stream inlet and an air stream outlet. The air filter comprising a filter media disposed on a support is disposed within, or secured to, the housing and an air permeable hydrocarbon adsorbing material is disposed between the filter media and the support at the air stream outlet end of the filter. The hydrocarbon adsorbing material is situated proximate to the clean air side to adsorb hydrocarbon emissions in an air stream flowing from the air stream inlet through the filter media and hydrocarbon adsorbing material and exiting through the air stream outlet, typically to an inlet of an engine air induction system.

In an alternate embodiment, the present integrated air filter and hydrocarbon adsorbing apparatus comprises a housing securing an air filter having an air stream inlet and an air stream outlet and a hydrocarbon adsorbing material directly disposed on a portion of the air filter adjacent the air stream outlet.

These and other features and advantages of the invention will be more fully understood from the following description of certain specific embodiments of the invention taken together with the accompanying drawings.

### BRIEF DESCRIPTION OF THE DRAWINGS

Referring now to the drawings, which are meant to be exemplary, not limiting, and wherein like elements are numbered alike in the several Figures:

FIG. 1 is a partially broken top view of one embodiment of the present integrated air filter and hydrocarbon adsorbing apparatus.

FIG. 2 is a view taken along the section A-A of FIG. 1 showing further detail of the embodiment of FIG. 1.

FIG. 3 is an enlarged view of the area 3 of FIG. 2.

### DESCRIPTION OF THE PREFERRED EMBODIMENT

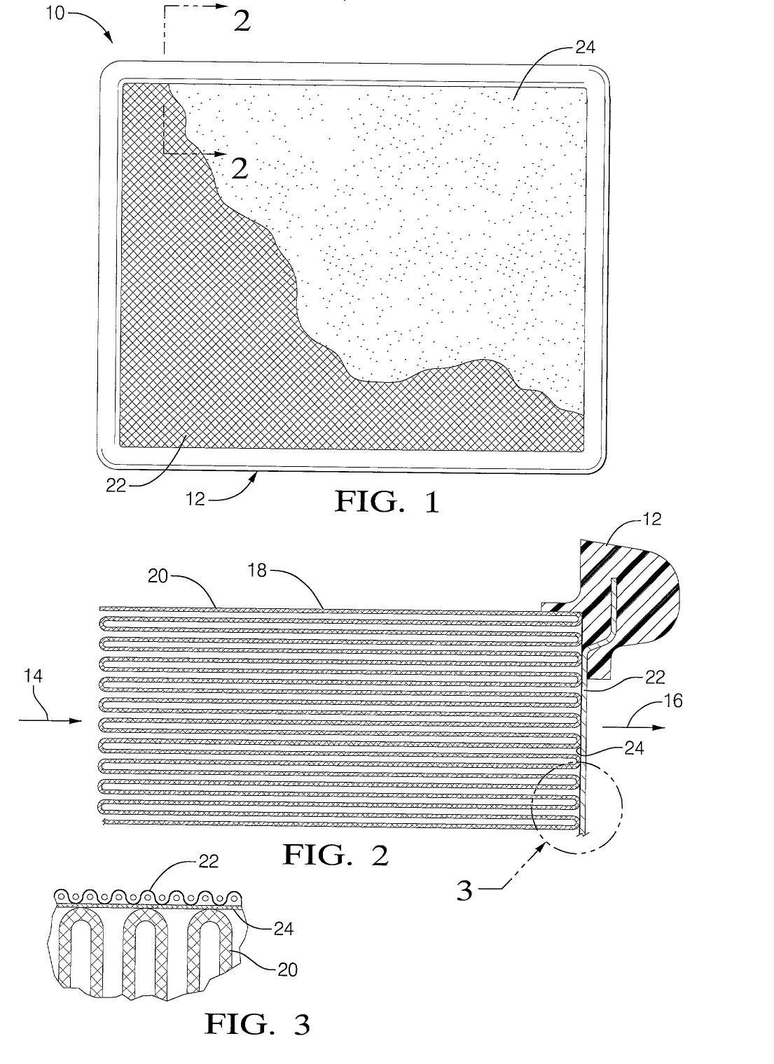

FIGS. 1-3 illustrate one possible embodiment of an integrated air filter and hydrocarbon adsorbing apparatus 10 according to the present invention. The integrated air filter and hydrocarbon adsorbing apparatus 10 has an air stream inlet 14 and an air stream outlet 16 (inlet 14 and outlet 16 depicted by arrows in FIG. 2) for flowing an air stream to be treated through air filter 18. The air filter 18 (shown in FIG. 2) comprises a filter media 20 disposed on a support 22, such as wire screen support 22. The screen support 22 may comprise wire, plastic, or any material suitable for providing sufficient support in the intended environment.

An air permeable hydrocarbon adsorbing material 24 is disposed beneath the screen support 22 so as to be retained between the filter media 20 and the screen support 22 at the air stream outlet end 16 of the filter 18. A portion of the screen support 22 is broken away in FIG. 1 to illustrate placement of the hydrocarbon adsorbing material 24 beneath the support 20. As best seen in FIG. 2, the hydrocarbon adsorbing material 24 is thus sandwiched between the filter paper 20 and the screen support 22 on the “clean air side” of the filter 18.

In operation, a contaminated air stream flows into the air stream inlet 14, passes through the filter media 20 and the hydrocarbon adsorbing material 24, and exits as a clean air stream at the air stream outlet 16. The hydrocarbon adsorbing material 24 is thus situated in the air stream at the clean air side to adsorb gasoline vapors migrating from the engine to the air induction system inlet. Air stream outlet 16 may be in fluid communication with an inlet of the engine air induction system, for example, or with an exhaust to the environment.

FIG. 2, view taken along the section A-A of FIG. 1, provides further detail of the embodiment shown in FIG. 1. In a preferred embodiment, the filter media 20 comprises folded filter paper 20. The contaminated air stream enters at the air inlet 14 side, which is the side furthest away from the hydrocarbon adsorbing material 24 and metal screen 22. The perimeter of the filter 18 comprising the filter media 20 and support 22 at the outlet end 16 is secured by the housing 12. The housing 12 may comprise any desired configuration, such as a cylindrical type housing or a structure disposed at one or both ends of the apparatus 10. In a preferred embodiment, the integrated air filter hydrocarbon adsorbing apparatus 10 is encapsulated with polyurethane foam.

FIG. 3 provides an enlarged view of the area 3 of FIG. 2, showing the placement of the hydrocarbon adsorbing material 24 between the screen support 22 and the filter paper 20. By sandwiching the hydrocarbon adsorbing material 24 between the filter paper 20 and the screen support 22, the hydrocarbon adsorbing material 24 is afforded structure on both sides thereof, thus enhancing the durability and working life of the hydrocarbon adsorbing material 24.

The mounting arrangement affords the hydrocarbon adsorbing material 24 the durability to survive in the field for about 30,000 miles, the recommended interval between air filter replacements. Further, disposing the hydrocarbon adsorbing material 24 on the clean air side of the air induction system reduces or eliminates contamination thereof The hydrocarbon adsorbing material 24 resides in the air stream, perpendicular to the airflow, thereby maximizing its adsorption effectiveness as well as its purge cycle. In addition, the hydrocarbon adsorbing material 24 is situated in the widest part of the air stream, thus minimizing its impact on system restriction and stress due to air flow.

Any suitable hydrocarbon adsorbing material may be used for the hydrocarbon adsorbing material 24. Suitable materials include, for example, activated carbon cloth, among others. In a preferred embodiment, the hydrocarbon adsorbing material comprises a thin, air permeable cloth, having a thickness of less than about 1 millimeter. In another preferred embodiment, the hydrocarbon adsorbing material comprises an activated carbon cloth that adds only about 0.4″ or less of water restriction at 150 cubic feet per minute airflow. Thus, the present integrated air filter and hydrocarbon adsorbing apparatus affords about one-tenth the restriction encountered with extruded carbon monoliths.

The hydrocarbon adsorption capacity of the flat carbon cloth is sufficient for most vehicle applications. For applications requiring additional adsorption capability, the cloth may comprise multiple layers or may be folded or otherwise disposed so as to increase the adsorption capacity. For example, the cloth may be folder over once to double the adsorption capacity. In addition to carbon cloth, any flat air permeable hydrocarbon adsorbing media may be used for the hydrocarbon adsorbing material 24. For example, woven carbon fibers or a spun bound material impregnated with carbon powder or containing carbon granules may be used.

To prepare the apparatus 10, the hydrocarbon adsorbing material 24, such as carbon cloth 24, is cut to fit over the folded filter paper 20. The screen support 22 is placed on top of the filter paper 20 and cloth 24, sandwiching the cloth 24 between the filter paper 20 and the screen support 22 and the components are bound together, such as with a polyurethane foam encapsulent.

In an alternate embodiment, the integrated air filter and hydrocarbon adsorbing apparatus comprises a hydrocarbon adsorbing material disposed directly on a portion of the filter media 20 adjacent the clean air side (i.e., air stream outlet 16 end) of the filter 18. The hydrocarbon adsorbing material may comprise any suitable material, such as carbon powder. The hydrocarbon adsorbing material may be mixed with a carrier or binder, to enhance coating or impart other properties, as desired. In this embodiment, the filter may comprise any material providing sufficient porosity to provide the required airflow during use, including, but not limited to, paper or plastic. For example, the filter may comprise a graduated porosity paper filter having a higher porosity at the carbon-coated portion and a relatively lower porosity at the non-carbon coated portions. Alternately, the filter may comprise a paper filter having a substantially uniform porosity that is sufficiently high to allow adequate airflow even after coating with carbon powder at the air outlet end. In a most preferred embodiment, the filter comprises a plastic filter, such as a spun plastic filter mat.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. An integrated air filter and hydrocarbon adsorbing apparatus comprising:
a housing securing an air filter having an air stream inlet and an air stream outlet and comprising a filter media disposed on a support;
an air permeable hydrocarbon adsorbing material disposed between said filter media and said support at said air stream outlet end of said filter;
wherein said hydrocarbon adsorbing material is situated to adsorb hydrocarbon emissions from an inlet of an engine air induction system.

2. The apparatus of claim 1, wherein said filter media comprises folded filter paper.

3. The apparatus of claim 1, wherein said hydrocarbon adsorbing material has a thickness of less than about 1 millimeter.

4. The apparatus of claim 1, wherein said hydrocarbon adsorbing material adds about 0.4″ or less of water restriction at 150 cubic feet per minute airflow.

5. The apparatus of claim 1, wherein said hydrocarbon adsorbing material comprises activated carbon cloth, woven carbon fibers, spun bound material impregnated with carbon powder, carbon granules, or a combination thereof.

6. The apparatus of claim 1, wherein said hydrocarbon adsorbing material comprises layers of carbon cloth, wherein the number of layers are selected so as to provide a sufficient adsorption capacity for the particular application.

7. The apparatus of claim 1, wherein said hydrocarbon adsorbing material comprises a folded carbon cloth, said carbon cloth being folded so as to provide a sufficient adsorption capacity for the particular application.

8. The apparatus of claim 1, wherein said support comprises a wire screen or a plastic screen.

9. An integrated air filter and hydrocarbon adsorbing apparatus comprising:
a housing securing an air filter, said air filter having an air stream inlet and an air stream outlet and comprising a filter media disposed on a support.
a hydrocarbon adsorbing material directly disposed on a portion of said air filter adjacent said air stream outlet.

10. The apparatus of claim 9, wherein said hydrocarbon adsorbing material comprises carbon powder.

11. The apparatus of claim 9, wherein said air filter comprises a plastic filter.

12. The apparatus of claim 9, wherein said air filter comprises a paper filter.

13. The apparatus of claim 9, wherein said air filter comprises a graduated porosity filter.

14. The apparatus of claim 9, wherein said air filter comprises a filter having a substantially uniform porosity.
